(19) United States
(12) Patent Application Publication
(10) Pub. No.: US 2017/0011610 A1
(43) Pub. Date: Jan. 12, 2017

(54) DETECTING PERSONAL ACTIVITY BY MEANS OF BATTERY-POWERED MOTION DETECTORS INCLUDING WIRELESS TRANSMITTERS

(71) Applicant: Arc Informatics Limited, Chelmsford, Essex (GB)

(72) Inventors: Nigel MILLS, Brentwood, Essex (GB); Danny Scott, Halstead, Essex (GB)

(21) Appl. No.: 15/121,798

(22) PCT Filed: Feb. 24, 2015
(86) PCT No.: PCT/GB2015/050518

§ 371 Date: Aug. 26, 2016

(30) Foreign Application Priority Data
Feb. 26, 2014 (GB) 1403373.2

(51) Int. Cl. G08B 21/04

(52) U.S. Cl. CPC G08B 21/0415

(57) ABSTRACT

A method of detecting personal activity within a dwelling using at least one battery-powered motion detector connected wirelessly to a control system for transmission of activity reports. Detection of activity starts a minimum reporting period timer and the time of subsequent detected activity is recorded and updated on each subsequent activity. At the expiry of the minimum reporting period, the times of the first and latest detected activities are transmitted to the control system. The detector awaits an acknowledgement from the control system to indicate successful transmission and following receipt of the acknowledgement, the minimum reporting period timer is re-started on detection of the next activity. In this way the number of reports transmitted wirelessly to the control system is reduced so extending battery life.

This invention relates to improvements in the methods of and apparatus for detecting normal personal activity within a dwelling having a plurality of functional spaces, as is described in WO2014/174252, referred to hereinafter as “said application.” The entire content of said application is deemed to be incorporated herein by way of this reference thereto.

Said application describes and claims a method and apparatus for detecting normal personal activity primarily intended for use with people who may have a limited ability to look after themselves or who otherwise might be vulnerable in some way, though the invention of said application is not limited to such use. In the event that there is no normal personal activity detected within a dwelling by a person being monitored, it may be presumed that the person is in some difficulty. As such, an alarm is raised so a nominated person may make contact, such as by a telephone call or a personal attendance, with the monitored person, to check whether that person may need help and to ensure that person has the earliest possible review of his/her situation.

The apparatus described in said application uses a plurality of motion detectors connected to a control system which processes the outputs of the detectors and decides whether an alarm is to be raised. It is envisaged that the apparatus will be installed in a dwelling only once a person living there has a need for it, and so the apparatus will not be fitted into the dwelling during initial construction. In order to facilitate the installation of the detectors with minimum disruption and in the quickest possible manner, it is highly advantageous to use battery-powered detectors which are connected to the control system wirelessly. Each detector thus includes a radio frequency transmitter which sends an activity report to the control system when activity has been detected in the area monitored by that detector.

Inevitably, the batteries of the detectors and transmitters have a limited life and must be changed on a routine basis before exhausted. However, frequent battery replacement is both expensive and time consuming and so it is advantageous to extend the battery life for as long as possible. This may be done by limiting the frequency at which activity reports may be sent by any one detector to the control system.

It is known to use battery-powered activity detectors for burglar alarm systems, which detectors are configured to limit how often activity can be reported. In effect, this introduces a “minimum reporting period” in order that continuous activity within the monitored space does not rapidly exhaust the battery that powers the detector and transmitter. This is a perfectly viable solution in a burglar alarm system where normally there should be no activity at all within a property, following setting of the alarm. When a person exits a property and sets the alarm, many detectors will be triggered but after an initial activity report further activity reports will be inhibited during the minimum reporting period. That period should be sufficiently long to allow a person to leave the property on the presumption that no break-in is likely to occur in that period, but then to resume normal reporting shortly after the person has left the property. Typically, the minimum reporting period can be of the order of several minutes; one practical example uses a minimum reporting period of four minutes.

In a system using similar activity detectors to determine where in a multi-room dwelling a single occupant currently rests, this approach cannot be used. For example, in a small flat an occupant may leave the lounge to pick up a newspaper in the hall following delivery to the dwelling. The lounge detector may report activity as the person leaves the lounge, and the hall detector may report activity as the person enters the hall, but on a prompt return to the lounge the lounge detector may be inhibited from reporting further activity as such an activity report would fall within the minimum reporting period. Consequently, the control system would not be notified that the person has re-entered the lounge before sitting immobile for some time, reading the paper. The control system would reason that the latest activity (and hence the person) was in the hall, whereas in fact that person may be sitting quietly in the lounge. Typically, the control system would use the location of the person to monitor that person's wellbeing, based on different time periods of inactivity depending on the room currently occupied by the person. As such, in this example the control system may well activate a false alarm, on the basis that the person had been in the hall for an unexpectedly long time, whereas if the system correctly knew the person was in the lounge, a much longer time period of inactivity would be appropriate before an alarm should be raised.

It is a principal aim of this development of the invention of said application to modify the detector design and reporting mechanism to allow a control system correctly to determine in which room of a dwelling the latest activity occurred (and hence the room in which the occupant is), even if the detector in that room was not the most recent to report activity. A further aim of this invention is to extend the service life of batteries of battery operated detectors including wireless transmitters for transmitting activity reports.

According to this invention, there is provided a method of detecting normal personal activity within a dwelling having a plurality of functional spaces with at least one motion detector arranged in each space to be monitored and a control system connected to the detectors to receive activity reports therefrom indicative of detected movement, at least one of the motion detectors being battery-powered and including a wireless transmitter for transmitting an activity report to the control system, in which method the control system:

awaits an activity report from a detector indicative of movement in a space monitored by that detector;

awaits an activity report from a detector monitoring another space indicative of movement in that another space; and

issues an alert signal in the event an alert period expires following receipt of the first activity report and no activity report has been received from another detector monitoring another space, said alert period being specified by at least one of a user of or the operational characteristics of the system; and when said at least one motion detector detects activity and an activity report is transmitted to the control system, the timing of a minimum reporting period is started to inhibit further activity reports being transmitted by the detector until said period has expired, the detector during this period recording the time of the first activity following starting of the timing and also the time of the latest activity, and on expiry of the minimum reporting period the detector transmits to the control system said times of the first and latest activities.

It will be appreciated that the transmission of an activity report by the detector to the control system uses considerable battery power, but by arranging the detector to have a minimum reporting period following the transmission of an activity report before another activity report can be sent, battery usage can be minimised. However, the detector is not “blind” to any activity during that period as the detector still recognises activity but does not immediately report that. Instead, the first activity starts a timer, recording how long ago the first activity was detected, and on subsequent activity, how long ago the latest activity was detected. Of course the time of the latest activity is continually updated, each time a further activity is detected. When the minimum reporting period expires, the detector reports how long ago both the first and latest activities occurred in the area being monitored.

The method can include a plurality of like battery-powered detectors each sending activity reports to the control system. The control system, on receipt of a first and latest activity report from one detector can integrate it with activity reports from other detectors received in any arbitrary order to determine the space of the dwelling where activity was most recently detected. Preferably, the first and latest activities are reported as a number of “ticks” (or clock cycles) ago, where a tick is an arbitrary time period common to all the like detectors, and is a fixed multiple of seconds or portion of a second. In this case, the detectors do not need to know accurate real time of day information; rather, the control system simply time-stamps the individual first and latest activities reports on reaching the control system, and from that time-stamp the control system can accurately place all the first and latest activities into “real time” (maintained by the control system) and subsequently integrate reports from many different detectors into a unified record of when and where activity was most recently detected.

It is highly preferred for the integrity of the system to ensure that no activity reports are lost through the wireless communication link, for example due to noise on the radio channel. This can be accomplished by using a two way radio system, with the control system sending acknowledgments of activity reports from the detectors and the detectors resending the information if not acknowledged by the control system. In such a two way system, where it is critical to be able to determine in which area the last activity was detected, it is important not to miss an activity while an activity report is being transmitted to the control system. For example, in the case of a detector exiting its minimum reporting period it might report its first and latest activities, including a latest activity being some number of ticks ago. Now if fresh activity is detected within the period between the transmission of that message and an acknowledgement being received or not received, there are two required outcomes:

1. If the acknowledgment is correctly received, then that fresh activity is considered to be a new first activity for incorporation in the next activity report to be transmitted after the next minimum reporting period expires.

2. If the acknowledgement is not correctly received, the activity report is presumed lost and that fresh activity is considered as an updated latest activity for inclusion in the next attempt at transmission of the first and latest activity report from that detector.

From the above, it will be appreciated that for any one detector, the timing of the minimum reporting period is re-started after a successful transmission of the first and latest activity data to the control system, as determined by receipt of an acknowledgement from the control system. Assuming there has been activity detected by that detector following the re-starting of the minimum reporting period, when that period expires, transmission of the new data will immediately begin and if no acknowledgement is received, the detector re-tries until an acknowledgement is received. The system may include a provision for appropriate action in the event that no acknowledgement is received, despite multiple attempts at transmission.

If the minimum reporting period expires but there has been no new activity, no transmission is made. Once activity is again detected, a transmission of that activity will immediately be made and the first activity timer is started. If re-transmission is required because no acknowledgement is received from the control system, the first activity timer will have incremented so allowing the control system to use its count accurately to place that activity in real time, no matter how long it takes to transmit the activity data, because each re-transmission sends the then current value of the first activity timer.

From this, it will be understood that with only occasional activity, the reporting of that is immediate, but with continuous repeated activity the reports are spaced by the minimum reporting period.

It may be advantageous to monitor at least one or both of the amount or frequency of activity in a space monitored by the or each detector. To achieve this in addition to the first and last activities described above, each detector could also count the number of times activity has been detected, and to include information about this in the first and latest activities report transmitted to the control system, which then could integrate this information to determine the amount and frequency of the activity in the space monitored by the detector while the occupant was there.

In addition, the or each detector could transmit status information (such as battery condition) to the control system on a regular basis, such as at a minimum once per day. To accommodate this a “maximum reporting period” timer can be incorporated and which is reset whenever an acknowledgement of status information is received, and if the period expires, causes the detector to transmit a message to the control system, including for example battery status.

Another possibility, where a plurality of detectors is located throughout the dwelling, is for at least some or all of the detectors to have an emergency button which can be used to summon assistance should the occupant be in some difficulty. Such an emergency button if implemented could remove the need for the minimum reporting period to expire before an activity report is sent from that detector, such that if the button is depressed, the detector could immediately transmit an emergency message or activity report to the control system. The detector would consider the emergency message duly passed to the control system only when an acknowledgment of that message has been received by the detector from the control system.

Alternatively, or in addition to the emergency button, at least one of the detectors may include an emergency call feature having a pull cord which extends from the detector down to floor level, or may be draped over furniture to the seat or bed of the dwelling occupant. The pull cord should, in effect, operate a switch in parallel with the emergency button, or perhaps actuate the emergency button itself.

The system may include one or more detectors for sensing the opening and closing of a door (such as an entrance door or a cupboard door) and which detectors are connected to the control system either with wires or preferably wirelessly. A preferred form of such a detector, known as a magnetometer, utilises the static nature of the Earth's magnetic field to detect rotational movement of the detector, and hence of the door to which it is attached. By storing the maximum and minimum values received from the magnetometer and the duration of such values (whilst excluding spurious values from its calculations), the magnetometer is capable of self-calibrating and detecting when a door is closed, open, or open ajar, such as when on a security chain. The rate of change of movement might also be measured to detect if a door has been opened suddenly, such as if “kicked-in” or pushed open violently from the outside.

In a system such as described above with detectors reporting to the control system on activity, the activity reports are at intervals spaced somewhere between the minimum reporting period and the maximum reporting period. Battery life may be extended by arranging the detectors so as to be capable of receiving acknowledgements and any other commands from the control system only for a brief period after the transmission of an activity report to the control system, as battery life is rapidly diminished if detectors remain permanently in a “receive” mode. Because of this, it is not possible for the control system to broadcast a message to all the detectors, as very few if any of the detectors will be in receive mode at any one time. Hence it becomes impossible to make major system wide changes, such as the radio communication frequency.

It is proposed to address the above problem in the following manner. At any given time the control system knows (by virtue of the last activity report it has received from each detector) the maximum period before each detector will communicate with the control system again—i.e. the maximum reporting period from the last transmitted activity report. If the control system needs to implement a system wide change which must happen to all detectors simultaneously, such as a radio frequency change, the control system sets a time for this to occur soon after the time that the last detector is guaranteed to report by virtue of the maximum reporting period timer in each detector. Having picked this time, the control system, in each acknowledgement sent to each detector in the intervening time, calculates the number of “ticks” before this change is to occur, and includes this along with whatever system parameters need to be changed in the acknowledgment sent to each detector.

When this time arrives, all detectors are guaranteed to have sent an activity report to the control system and have been advised of the system wide parameter change, and so every detector in the system can switch to the new parameters at the same time.

This invention extends to a battery-powered motion detector including a wireless transmitter for transmitting an activity report to a control system and configured to operate in conjunction with a control system by way of a method of this invention as described above.

By way of example only, a practical implementation of a method of this invention will now be described with reference to the accompanying drawings, in which:

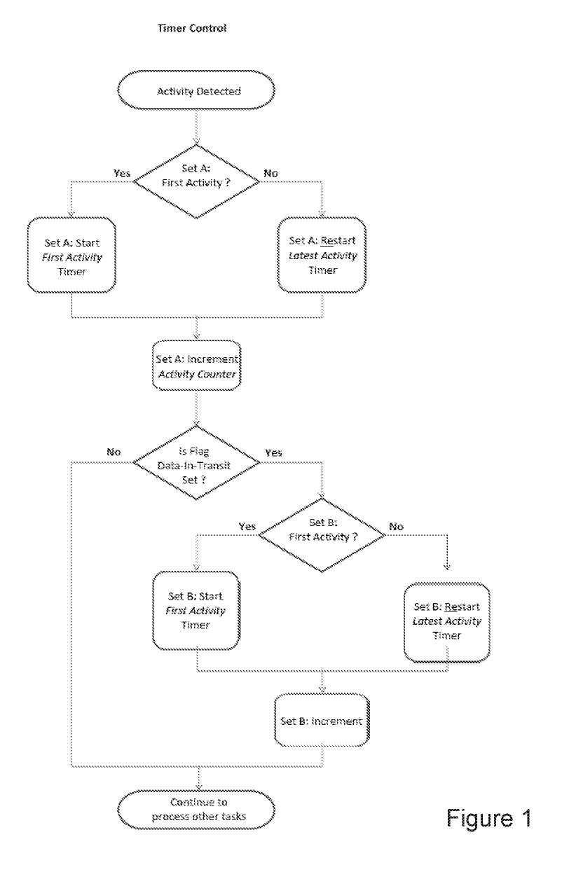

FIG. 1 is a flow chart showing the timer control for the method; and

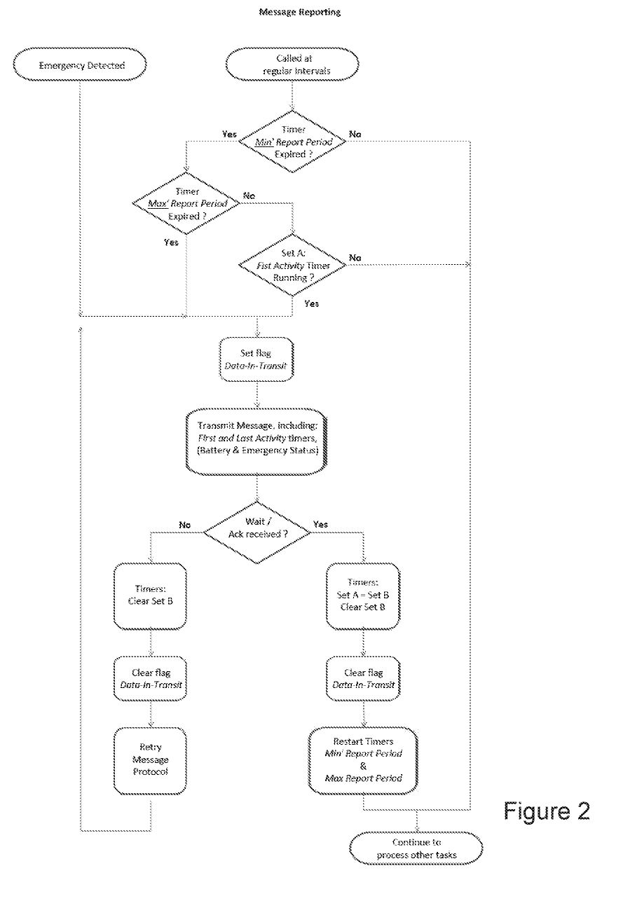

FIG. 2 is a flow chart showing the transmission of activity reports and the acknowledgements thereof, which activity reports and acknowledgements are also referred to herein as messages.

Each battery-powered detector includes a motion sensor, a transmitter/receiver for a two way radio connection to a control system and a processor programmed to perform the steps shown in FIG. 1. The processor runs two sets of timers (Set A and Set B), each of which has timers for first activity detected and latest activity detected. Further, the processor runs counters to accumulate the number of activities detected by each set of timers. The timers are arranged to respond to detected activities with fresh activity starting the first activity timer, and subsequent activity starting or restarting the latest activity timer. If the minimum reporting period has already expired, then the sending of the activity report is initiated when a fresh activity starts the first activity timer. If the sensor is currently waiting for the minimum reporting period to expire, then further activity detections starts or restarts the latest activity timer until the minimum reporting period expires and the sending of an activity report is initiated, as will be described below with reference to the situation where a detector is exiting its minimum reporting period.

When not inhibited from transmitting an activity report by the minimum reporting period timer, or when that timer expires if activity has been detected, the detector will initiate transmission of an activity report giving the timing of the first and latest activities detected thereby, the latest activity having occurred a number of clock cycles (ticks) previously. The first and latest activity timers continue to be updated as described in the following sections through the message generation, sending, and acknowledgement phases so that any delays (such as retries) in transferring the activity data to the control system do not compromise the timing information being transferred.

If fresh activity is detected within the period between the transmission of that message and an acknowledgement being received—or not—from the control system, one of two different outcomes is required:

1. If the acknowledgment is correctly received, then that fresh activity is considered to be a new first activity, to be transmitted after the next minimum reporting period expires.

2. If the acknowledgement is not correctly received, the report message is assumed lost, and in that case that fresh activity will be considered to be an updated latest activity for the next attempt at transmission of first and latest activity report, for that detector.

The above procedure is accomplished by using two sets of first and latest activity timers, referred to as Set A and Set B, as shown in the flow charts. Normally the Set A timers are utilised, but when the Set A first and latest activity timer report is transmitted but before a decision has been made on whether that activity report has been lost or not, then the Set A and Set B timers are both updated on fresh activity in that short interval between transmission of the activity report and the receipt of the acknowledgement. The fresh activity loaded in Set A is considered as an updated latest activity for the activity report just transmitted; the fresh activity loaded in Set B is considered as the first activity for a new activity report, and any subsequent activity is then regarded as the latest activity.

If the acknowledgement is correctly received, the information in Set A is discarded, and Set A is loaded with the values from Set B, along with the discarding of Set B, so the fresh activity has correctly been recorded as a first activity.

However if the acknowledgement is not received, the information in Set B is discarded, and any subsequent attempt to report the activity recorded by the detector will include the fresh activity simply as the latest activity for this detector, as recorded in Set A.

In this way, accurate first and latest activity reports from the detector are sent to the control system correctly recording activity that might occur while activity reports and acknowledgements are being exchanged between detector and control system.

The processor of the detector is also programmed to perform the steps shown in FIG. 2, so far as the transmission of an activity report is concerned at the expiry of a minimum reporting period or if the emergency button has been operated. The routine shown in FIG. 2 is called at regular intervals or if the emergency button has been operated. It proceeds to send an activity report if the emergency button has been operated, or if the minimum reporting period has expired and there has been activity detected (Set A timers running). An activity report will also be sent if the maximum reporting period has expired.

Following transmission of an activity report, an acknowledgement is awaited from the control system. If such an acknowledgement is correctly received, processing continues as has been described above with reference to FIG. 1 with appropriate resetting of the timers; but if no acknowledgement is received then the transmitter retries to send the activity report, but modified as described above with an updated latest activity time if there has been fresh activity detected.

1. A method of detecting normal personal activity within a dwelling having a plurality of functional spaces with at least one motion detector arranged in each space to be monitored and a control system connected to the detectors to receive activity reports therefrom indicative of detected movement, at least one of the motion detectors being battery-powered and including a wireless transmitter for transmitting an activity report to the control system, in which method the control system:
awaits an activity report from a detector indicative of movement in a space monitored by that detector;
awaits an activity report from a detector monitoring another space indicative of movement in that another space; and
issues an alert signal in the event an alert period expires following receipt of the first activity report and no activity report has been received from another detector monitoring another space, said alert period being specified by at least one of a user of or the operational characteristics of the system;
and when said at least one motion detector detects activity and an activity report is transmitted to the control system, the timing of a minimum reporting period is started to inhibit further activity reports being transmitted by the detector until said period has expired, the detector during this period recording the time of the first activity following starting of the timing and also the time of the latest activity, and on expiry of the minimum reporting period the detector transmits to the control system said times of the first and latest activities.

2. A method as claimed in claim 1, wherein the first detected activity following the starting of the timing of the minimum reporting period starts timing by a first activity timer.

3. A method as claimed in claim 2, wherein subsequent detected activity following the starting of the timing of the minimum reporting period starts timing by a latest activity timer, and each subsequent detected activity resets the timing by that latest activity timer.

4. A method as claimed in claim 3, wherein at the expiry of the minimum reporting period, the timings determined by the first and latest activity timers are transmitted to the control system.

5. A method as claimed in claim 4, wherein the first and latest activity timers count clock ticks from commencement of the relevant timing period and the count at expiry of the minimum reporting period is transmitted.

6. A method as claimed in claim 4, wherein the control system time-stamps each received activity report of the first and latest activity and then calculates the real time of the first and latest activities.

7. A method as claimed in claim 1 and where there is provided a plurality of like battery-powered detectors each having a wireless transmitter for transmitting activity reports to the control system, in which method the control system receives the activity reports from detectors and integrates the first and latest activities of those activity reports into a real time order irrespective of the order in which those activity reports are received, to determine the space of the dwelling where activity was most recently detected.

8. A method as claimed in claim 1, wherein a two-way wireless radio link is established between the control system and the at least one detector to ensure that no activity reports from that detector are lost through the communication medium.

9. A method as claimed in claim 8, wherein following proper receipt of an activity report from the at least one detector, the control system transmits an acknowledgment to said detector of the activity report sent to the control system.

10. A method as claimed in claim 9, and where the acknowledgment is correctly received, then the next activity detected by that motion detector is processed as a new first activity and starts the timing of a new minimum reporting period to be transmitted after the that minimum reporting period expires; but where the acknowledgement is not correctly received the activity report is assumed lost, and the next activity detected by that motion detector is processed as an updated latest activity for the next attempt at transmission of the first and latest activity report.

11. A method as claimed in claim 10, wherein the motion detector includes two sets of timers for the first and latest activities detected by the motion detector, one set being used to generate an activity report for sending to the control system at the end of the minimum reporting period and the other set to record any activity detected between transmission of an activity report and receipt of a valid acknowledgement of that activity report, for use in a subsequent activity report.

12. A method as claimed in claim 1, wherein one or both of the amount or frequency of activity in an area monitored by a motion detector is monitored and wherein each detector is configured to count the number of times activity has been detected and the frequency of the detected motion, and each activity report transmitted to the control system includes information concerning this.

13. (canceled)

14. A method as claimed in claim 12, wherein the control system processes said information to determine the amount and frequency of the activity in the area monitored by the detector while an occupant was in the space monitored by that detector.

15. A method as claimed in claim 1, wherein the transmitter is arranged to transmit an activity report concerning detector status information to the control system at a predetermined frequency and wherein said at least one detector includes a maximum reporting period timer which is reset whenever an acknowledgement is received from the control system, but if a maximum reporting period expires the detector transmits an information message to the control system.

16. (canceled)

17. A method as claimed in claim 1, wherein the detector is furnished with an emergency button which when depressed causes an emergency message to be immediately transmitted to the control system.

18. A method as claimed in claim 1, wherein the detector is furnished with a pull-cord which when pulled causes an emergency message to be immediately transmitted to the control system.

19. A method as claimed in claim 17, wherein the control system transmits to the detector an acknowledgment of an emergency message transmitted by the detector to that control system, but in the event the detector receives no such acknowledgement, the detector re-transmits the emergency message.

20. A method as claimed in claim 8, wherein the control system is configured to send an acknowledgement of an activity report to a detector immediately after receiving an activity report; and the acknowledgement may include information to be acted on by the detector.

21. A method as claimed in claim 20 and where there is a plurality of like detectors, wherein information contained in an acknowledgement sent to a detector includes information concerning a system-wide change in configuration to be implemented by all said like detectors, and the timing of the system-wide change.

22. A battery-powered motion detector including a wireless transmitter configured to operate in conjunction with a control system for transmitting to the control system an activity report, the motion detector operating on a method as claimed in claim 1.
